(19) United States
(12) Patent Application Publication
(10) Pub. No.: US 2014/0203109 A1
(43) Pub. Date: Jul. 24, 2014

(54) INJECTION NOZZLE FOR AN INTERNAL COMBUSTION ENGINE

(71) Applicant: EFI HIGHTECH AG, Heiden (CH)

(72) Inventor: Heribert Otto GEISSER, Staad (CH)

(73) Assignee: EFI HIGHTECH AG, Heiden (CH)

(21) Appl. No.: 14/156,936

(22) Filed: Jan. 16, 2014

(30) Foreign Application Priority Data
Jan. 18, 2013 (EP) 13151831.8

(51) Int. Cl. F02M 61/18

(52) U.S. Cl. CPC F02M 61/1886; F02M 61/1833
USPC 239/584

(57) ABSTRACT

An injection nozzle (1), especially an injection orifice for an internal combustion engine, comprises a body (2) in which a nozzle needle (7) is displaceably guided; a pressure chamber (5) which communicates with a feed borehole (4) and via a passage with a spray chamber (6), wherein the passage (9) comprises a needle seat (9′) for cooperation with a needle tip (8) of the nozzle needle (7); and at least one injection orifice (10) via which the spray chamber (6) communicates with the outside of the body (2). The at least one injection orifice has a substantially bottleneck-like inner contour with at least one pre-chamber (14) which opens at one end with an inlet opening (13) into the spray chamber (6); and a guide channel (17) which is connected to the other end of the at least one pre-chamber (14) and communicates via an outlet opening (18) with the outside (dome) of the body (2). The at least one pre-chamber (14) has a diameter or cross-section at least in the inlet opening (13) which is at least 50% larger than the diameter or cross-section of the guide channel (17), wherein the at least one pre-chamber (14) comprises at least one constriction (15) with at least one narrowing section (16). A ratio of a length of the guide channel (17) to a length of the pre-chamber (14) lies in a range of 1:0.2 to 1:0.8.

### CROSS-REFERENCE TO RELATED APPLICATION

This application claims priority to European Application No. 13 151 831.8 filed Jan. 18, 2013, the disclosure of which is incorporated herein by reference in its entirety

### BACKGROUND AND SUMMARY OF THE DISCLOSURE

The invention relates to an injection nozzle, especially an orifice nozzle, for an internal combustion engine. The invention especially also relates to the shape of the injection orifice of such an injection nozzle.

Injection nozzles are provided to inject liquid, gaseous or powdery (powdered) substances, especially fuels, under (high) pressure by an injection pump or a pressure line system (common rail system) into the combustion chamber of an internal combustion engine such as compression ignition internal combustion engines, for example, diesel engines, in such a way that the internal combustion engine achieves the best possible efficiency (both ecologically and economically) in any operating state. The fuel/air mixture formation of the fuel in the combustion chamber and, therefore, the combustion sequence are relevantly influenced by the inner shape of the injection orifices of the injection nozzle.

There are different kinds of injection nozzles, of which the so-called orifice nozzle will be discussed here. The orifice nozzle is used in internal combustion engines with direct injection, because an especially fine distribution of the fuel is achieved with this nozzle. Orifice nozzles are arranged as single-hole nozzles and multi-hole nozzles. Single-hole nozzles comprise an injection orifice which is arranged in the direction of the nozzle axis or laterally thereto.

Multi-hole nozzles can comprise, for example, up to 14 injection orifices, which are mostly arranged symmetrically with respect to each other. Single-hole and multi-hole nozzles are arranged on one or several levels to define the injection orifice geometry of the nozzle. The orifice diameter or orifice cross-section and orifice length influence the shape and penetration depth of the injection jet and its injection pattern. The orifice diameter depends on the configuration of the combustion chamber.

New injection systems for gas, diesel, heavy-oil and biomass internal combustion engines were developed by systematic research work in the last two decades, especially with the goal of providing an environmental friendly engine meeting EURO, TIER, IMO norms and optimal combustion of the fuels. This led to common rail systems with electronic monitoring units. An increase in the efficiency can be achieved with respect to ecology and economy in the case of good adjustment of all relevant components.

An arrangement of the inner contours of one or several injection orifices of a fuel nozzle can relevantly influence the injection process in the combustion chamber of compression ignition engines. One example for illustration is DE 39 34 587 C2, which describes a method for producing highly precise through-bores in workpieces comprising bottleneck-like injection orifices, especially in injection nozzles, by means of laser beams.

Document EP 2 365 207 A1 describes an injection nozzle for an internal combustion engine. The injection nozzle comprises at least one injection orifice with a substantially bottleneck-like inner contour.

It is the object of the present invention to provide an improved injection nozzle.

This object is achieved by an injection nozzle with the features of claim 1.

Accordingly, an injection nozzle, and an orifice nozzle for an internal combustion engine in particular, comprises a body in which a nozzle needle is displaceably guided, and a pressure chamber which communicates with an inlet passage and an injection chamber via a passage, wherein the passage comprises a needle seat for cooperation with a needle tip of the nozzle needle, and comprises at least one injection orifice by which the injection chamber communicates with the outside of the body. The at least one injection orifice has a substantially bottleneck-like contour with at least one pre-chamber, which opens with an inlet opening at one end into the injection chamber, and a guide channel which is connected to the other end of the at least one pre-chamber and communicates via an outlet opening with the outside (dome) of the body. The at least one pre-chamber has a diameter or cross-section at least in the inlet opening which is at least 50% larger than the diameter or cross-section of the guide channel, wherein the at least one pre-chamber comprises at least one constriction with at least one narrowing section. A ratio of a length of the guide channel to a length of the pre-chamber lies in a range of 1:0.2 to 1:0.8.

It was established on the basis of comparative studies, calculations and simulations that a special geometry of the inner contour of injection orifices offers special advantages. The injection orifice of the injection nozzle is provided with a substantially bottleneck-like inner contour. Such an injection orifice is also known as a bottleneck injection orifice or bottleneck spray hole.

The coaxial and sequential arrangement of functional regions of the injection orifice allows optimal adjustment to the demands of an associated combustion chamber of an internal combustion engine, e.g., in fuel/air mixture formation. It is preferable that the ratio of the length of the guide channel to the length of the pre-chamber lies in a range of 1:0.2 to 1:0.8.

This leads to the advantage over current injection systems, including common rail systems, that the injection pressure can be reduced substantially with a better ecological and economic effect, which leads to lower power consumption of the injection system and longer operational lifespan of all affected components.

It is a further advantage that in comparison with the prior art a longer operational lifespan is obtained for high-pressure pumps, pump elements, injectors, nozzles and the entire injection system as a result of lower pressure stresses.

It is advantageous that the substantially bottleneck-like inner contour comprises the following:
at least one pre-chamber which opens at one end with an inlet opening into the injection chamber, and a guide channel which is connected to the other end of the at least one pre-chamber and communicates via an outlet opening with the outside of the body.

The substantially bottleneck-like inner contour of the bottleneck injection orifice or bottleneck spray hole assumes the following functions:
inlet of a spray medium into the pre-chamber
receiving the spray medium in the pre-chamber
constricting function in the funnel region
guide function in the guide channel
outlet of the medium on the outside of the nozzle body (opening into the combustion chamber).

It is further advantageous that the inlet opening of the at least one pre-chamber is arranged with rounded inlet edges, thus leading to less friction loss and improving the long-term behavior of the injection nozzle. The rounded inlet edges of the inlet opening can be provided with the same rounding radii, thus offering an advantage in production.

The guide channel can be arranged cylindrically, in the shape of a truncated cone or in a combination of these shapes, by means of which the flow can be further influenced. In this respect, a diameter or cross-section of the at least one pre-chamber is larger by at least 50% at least in the region of the inlet opening than a diameter or cross-section of the guide channel. As a result, a constriction can be formed in the pre-chamber which comprises at least one narrowing section. The type of the flow of the flowing medium can be influenced by means of this narrowing section and the resulting gradual and/or abrupt changes in the diameter or changes in the cross-section which can be influenced. As a result, a laminar or turbulent or transitional type of flow can be set.

In one embodiment, the at least one pre-chamber in circular-cylindrical arrangement extends up to the at least one constriction with the at least one narrowing section. As an alternative thereto or in combination therewith, the at least one pre-chamber can be arranged in the manner of a truncated cone in sections, for example, in the direction of the guide channel.

The outlet opening of the guide channel can be arranged with sharp edges, by means of which it is possible to adjust the spray pattern of the supplied injection jet. It is advantageous if an outlet angle of the outlet opening of the guide channel which is formed by an outside surface of the body and an inner wall or the central axis of the guide channel is less than 90°.The outlet angle of the outlet opening of the guide channel can be arranged in the manner of a truncated cone.

The at least one injection orifice can comprise several functional regions (A-E) over its entire length, which functional regions are arranged on the same axis sequentially one behind the other and rotationally symmetrically. These functional areas can be arranged due to their division individually in such a way that the injection jet is provided optimally for the internal combustion engine to be assigned. This mechanical-hydraulic optimization of the functional areas can be superimposed by means of an electronic engine control unit (EECU) with additional optimal boundary conditions and parameter settings and states.

Of the functional areas, a first functional area (A) can comprise the inlet opening, a second functional area (B) the at least one pre-chamber, a third functional area (C) the at least one constriction, a fourth functional area (D) the guide channel and a fifth functional area (E) the outlet opening.

It is also possible that the same functional areas are arranged several times one behind the other, such as two second functional areas with two pre-chambers and two third functional areas with constrictions. As a result, a graduated pressure build-up can occur in the pre-chambers. It is also possible that, instead of a pressure build-up an intermediate stage can be provided with a pressure reduction, e.g. with an expansion.

The bottleneck-like functional packet (A-E) can be introduced in modulated drilling operations from the outside to the inside into the injection orifice of the injection nozzle. Different machining methods are possible, for example, laser machining.

Alternatively, the bottleneck-like functional packet (A-E) can also be combined in a modular unit and be pressed into a cylindrical injection orifice. This can facilitate production sequences since the machining of the injection orifice for producing the inner contour can be made at another location.

The substantially bottle-like inner contour of the injection orifice depends further at least on the inner shape, the volume, the air swirling and the combustion pressure of an associated combustion chamber of the internal combustion engine.

A shape of the injection orifice, which has a substantially bottle-like inner contour, of an injection nozzle can be realized according to the information described above.

The injection nozzle in accordance with the invention can be used both for use for the injection of fuels in powdery, liquid or gaseous form into the combustion chamber of combustion units such as internal combustion engines, and also for use for the atomization of powdery, liquid or gaseous media.

Moreover, advantageous adjustments to a large variety of requirements of internal combustion engines in the combustion chamber concerning the injection jet can also be made in such a way that the borehole length ratios of the individual functional areas can be adjusted in a variable way.

It is therefore possible with the information as described above to especially adjust the injection orifice with its inner contour or the inner shape of the injection orifice or the general shape of the injection orifice to the configuration of a respectively associated combustion chamber. This leads to a large number of variants of ratios of the functional areas such as lengths, widths, diameters, cross-sections depending on the injection pressures. With the help of respective simulation methods, the respective geometrical conditions can be adjusted to and optimized for the respective purpose, so that optimal states are obtained concerning combustion, fuel consumption and operational lifespan of the components.

### BRIEF DESCRIPTION OF THE DRAWINGS

The invention will be explained below in closer detail by reference to embodiments shown in the enclosed drawings, wherein:

FIG. 1 shows a schematic partial sectional view of an injection nozzle in accordance with the invention as an orifice nozzle in the closed position;

FIG. 2 shows a schematic partial sectional view of the injection nozzle according to FIG. 1 in the open position;

FIG. 3 shows a schematic sectional view of an injection orifice of the injection nozzle in accordance with the invention;

FIG. 4 shows an enlarged view of an inlet opening of the injection nozzle in accordance with the invention according to FIG. 3, and

FIG. 5 shows an enlarged view of a pre-chamber with a constriction of the injection nozzle in accordance with the invention according to FIG. 3.

### DETAILED DESCRIPTION OF THE DRAWINGS

The same components or functional units with the same function are provided with the same reference numerals in the drawings.

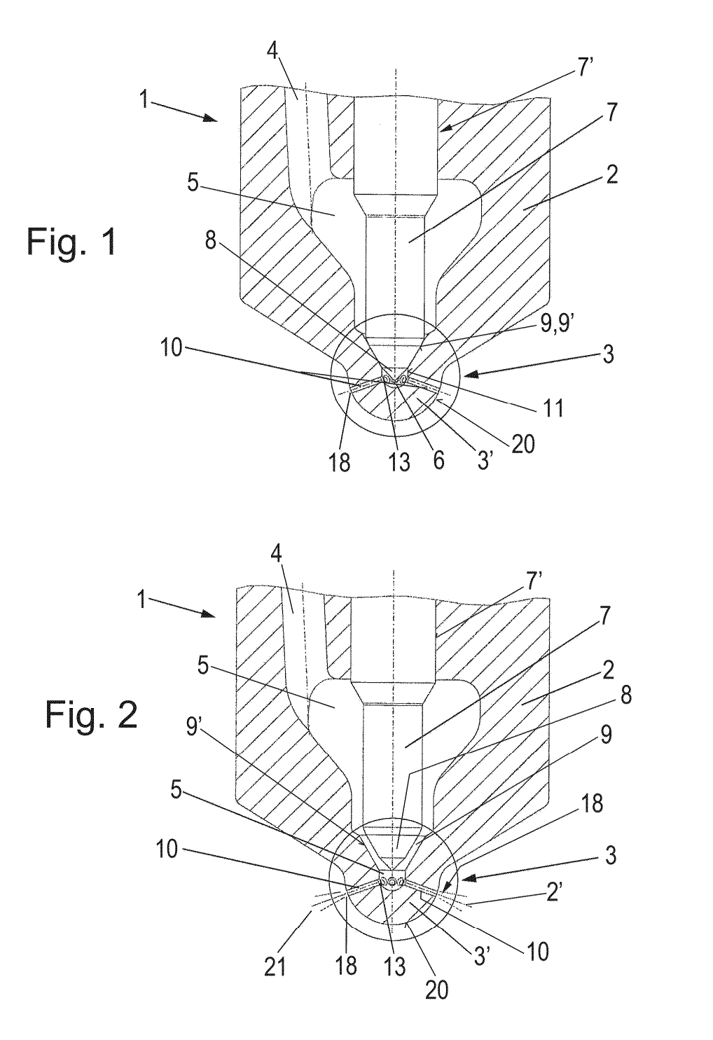

FIG. 1 shows a schematic partial sectional view of an injection nozzle 1 in accordance with the invention as an orifice nozzle in the closed position. FIG. 2 shows this injection nozzle 1 in the open position.

FIGS. 1 and 2 only show the bottom region of a body 2 of the injection nozzle 1 with a nozzle dome 3 (emphasized by a circle). The body 2 has a circular cross-section in the upper part of the injection nozzle 1, in which a nozzle needle 7 is disposed in the longitudinal direction of the body 2 in a longitudinally movable manner in a borehole 7′. The borehole 7′ converges into a pressure chamber 5 formed into the body 2. A feed borehole 4 is arranged in the body 2 laterally parallel to the borehole 7′. The feed borehole 4 opens at its bottom end into the pressure chamber 5, which narrows downwardly into a passage 9. The passage 9 comprises a conical needle seat 9′ and finally opens into a spray chamber 6 which is arranged in the nozzle dome 3 of the injection nozzle 1 with a rounded base. The body 2 of the injection nozzle 1 is arranged in a semi-spherical way as the nozzle dome 3 and has a lower wall thickness 3′ than at the top. Two injection orifices 10 extend in this example through this wall thickness 3′ of the nozzle dome 3, which open through an inwardly disposed spray chamber wall 11 through one respective inlet opening 13 into the rounded base of the spray chamber 6 and through one respective outlet opening 18 into an outside surface 20 of the nozzle dome 3.

The nozzle needle 7 extends from the borehole 7′ through the pressure chamber 5 into the passage 9 up to the spray chamber 6. The nozzle needle 7 tapers in this case into a conical needle tip 8, which cooperates together with the conical needle seat 9′ of the passage 9 as a tight valve seat.

The nozzle needle 7 is longitudinally adjustable by means of a drive (not shown), for example, mechanically, electromagnetically or also via the rising pressure of fuel in the pressure chamber 5. For the purpose of opening the needle seat 9′, the nozzle needle 7 is moved upwardly by said drive. This open position of the injection nozzle 1 is shown in FIG. 2, wherein the conical needle tip 8 has been retracted from the needle seat 9′. Fuel, which is pressurized in the pressure chamber 5 and is also supplied under pressure through the feed borehole 4, now flows from the pressure chamber 5 through the passage 9 into the injection chamber 6 and from there through the injection orifices 10 as a respective injection jet to the outside into the combustion chamber of an internal combustion engine (not shown).

The respective injection jet 21 is influenced among other things with respect to its spray pattern by the geometry of the respective injection orifice 10. Its speed, type of flow, pressure and pressure propagation continue to play a specific role, among other things.

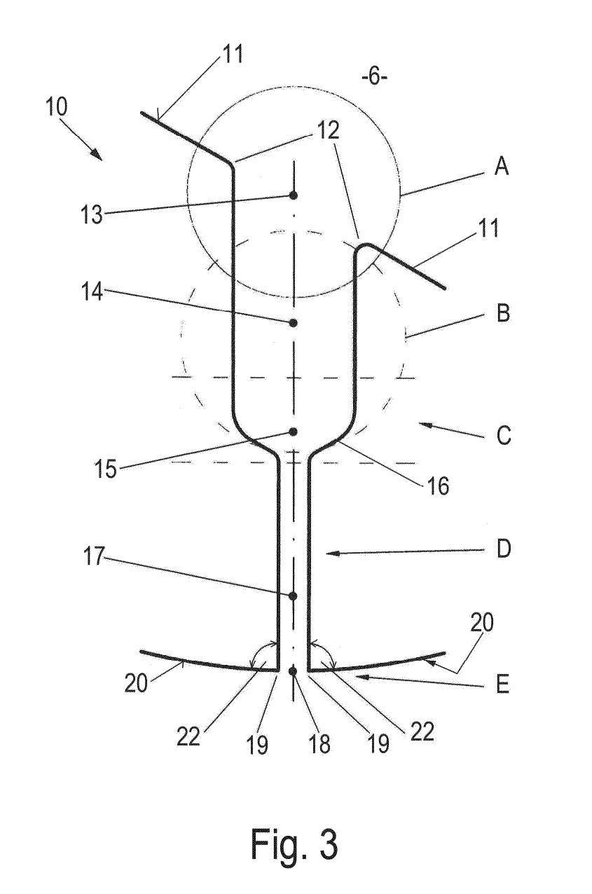

FIG. 3 shows a schematic sectional view of a spray hole of the injection nozzle 1 in accordance with the invention.

The injection orifice 10 in FIG. 3 is known as a bottleneck spray hole due to its shape. Such injection orifices 10 are formed in a large variety of bodies 2 of injection nozzles 1 in the nozzle dome 3 made of hardened special steels (e.g. DUALLOY). The nozzle needle 7 is made of special steel or ceramic materials.

On the basis of the inlet opening 13 which is introduced into the spray chamber wall 11 of the spray chamber 6, the injection orifice 10 extends at first in a pre-chamber 14, which is arranged in a circular-cylindrical way for example, and then converges into a constriction 15 with a narrowing section 16 like a bottle with a bottleneck, and a guide channel 17. A diameter or cross-section of the pre-chamber 14 is at least 50% larger than a diameter of cross-section of the guide channel 17. The end of the guide channel 17 opens into the outlet opening 18 in the outside surface 20 of the nozzle dome 3. The injection orifice 10 has a rotationally-symmetric bottle shape substantially over the entire longitudinal section.

The injection orifice 10 comprises functional areas A to E, which are indicated partly by circles, reference numerals and horizontal lines and which are provided with different functions.

The solid circle at the inlet opening 13 identifies the first functional area A comprising a fuel inlet. FIG. 4 shows an enlarged illustration of the inlet opening 13 of the injection nozzle 1 in accordance with the invention according to FIG. 3. In this case, an inlet edge 12 of the inlet opening 13 is rounded off. The hatched regions indicate contour variants of the spray chamber wall 11 in the spray chamber 6 in the region of the inlet opening 13. This indicates one of several possible variants.

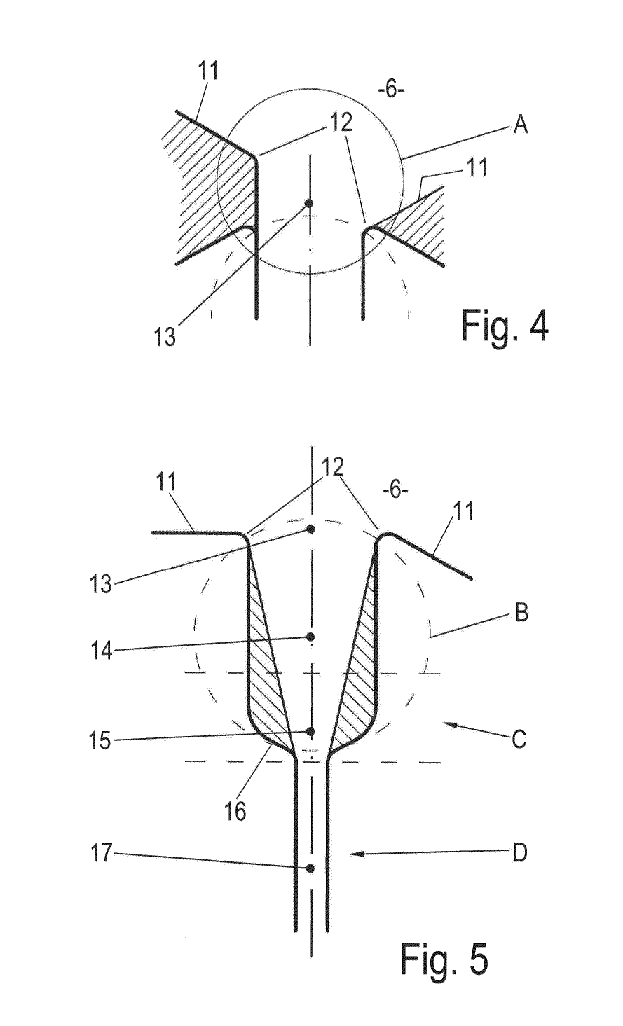

The dashed circle at pre-chamber 14 identifies the second functional area B. This is further illustrated in FIG. 5, which shows an enlarged illustration of the pre-chamber 14 with the constriction 15 of the injection nozzle 1. In this case, a diameter or cross-section of the pre-chamber 14 is at least 50% larger at least in the region of the inlet opening 13 than a diameter or cross-section of the guide channel 17.

The area between the dashed horizontal lines identifies functional area C of the constriction 15, which is bounded at the lower end by functional area D of the guide channel 17.

Finally, a final functional area E with the outlet opening 18 is provided.

Pressure is built up in the fuel flowing from the inlet opening 13 to the outlet opening 18 in the functional area B of the pre-chamber 14 during the opening of the needle seat 9′ (see FIG. 2) via the constriction 15 with the funnel-shaped narrowing section 16 to the subsequent guide channel 17, wherein preliminary dosing is performed. The flow rate of the fuel is subject to an only slight contraction in the pressure propagation in the pre-chamber 14 and leads to a time-precise injection over all injection orifices 10 of the injection nozzle 1 (see FIGS. 1 and 2). In comparison with current common rail systems, the injection pressure can be reduced substantially in combination with an improved ecological and economic effect, which leads to a lower power consumption of the system and, as a result of lower pressure stresses of the involved components, to a longer operational lifespan of high-pressure pumps, pump elements, injectors, nozzles and the entire injection system.

The functional area C of the constriction 15 with the funnel-like narrowing section 16 is arranged as a kind of a control cam, which is indicated in FIG. 5 by contour variants with hatched regions. Two such contour variants are indicated here by an arrangement in form of a truncated cone and a circular-cylindrical arrangement (without the hatched area) of the pre-chamber 14. Depending on the arrangement, this control cam influences the type of fuel flow in such a way that the type of flow will vary, e.g. it is laminar or turbulent. The flow velocity of the fuel or an injection medium will increase considerably in this phase. The negative effect of lower system pressures is compensated by the configuration and the functionality of the funnel-like narrowing section 16.

In the phase that follows this compression process or in the subsequent functional area D of the guide channel 17, the flowing fuel is guided and concentrated as a fuel jet in such a way that it can be made available in a specifically adjusted form (e.g. bush-like, stretched etc) to the combustion chamber arranged by the designer of the internal combustion engine.

In the last functional area E with the outlet opening 18, the borehole of the guide channel 17 is provided at the outlet opening 18 with a sharp-edged flow separation edge 19, wherein an outlet angle 22, which is formed by the outside surface 20 or the outside wall of the nozzle dome 3 and the inner wall or the central axis of the guide channel 17, lies beneath 90° if possible.

The dimensioning of such injection orifices 10 as bottleneck injection orifices or bottleneck spray holes with respect to different diameters or cross-sections, lengths of the individual functional areas, the configuration of the shape of the funnel in the narrowing section 16 and the dimensional relationships of the individual functional areas with respect to each other can be optimized for example by way of a simulation model. This simulation model can also simulate the flow conditions of different injection media. The calculation basis is formed by the combustion chamber provided by the designer of the internal combustion engine (in form and volume), the fuel (with respect to composition, viscosity, density) and the weighting of the objective (more economy or more ecology). The optimization of the shape occurs in any case by iteration trials.

In one embodiment, the ratio of a length of the guide channel 17 (which in this case is between the narrowing section 16 and the outlet opening 18—see FIG. 3) and a length of the pre-chamber 14 (which in this case is between the inlet opening 13 and the narrowing section 16—also see FIG. 3) lies in a range of 1:0.2 to 1:0.8.

The injection orifice shape or inner contour of the injection orifice 10 is adjusted in the aforementioned embodiments according to the arrangement of an associated combustion chamber. The factors of the inner shape of the combustion chamber, the volumes, air swirling and combustion pressure play a relevant role in this respect concerning the arrangement of the injection orifice 10.

The embodiment described above does not limit the invention. It can be modified within the scope of the enclosed claims.

For example, the injection orifice 10 can comprise more than one pre-chamber 14, wherein several second functional areas B are provided. Therefore, several narrowing sections 16 and thus several functional areas C are possible.

### LIST OF REFERENCE NUMERALS

1 Injection nozzle
2 Body
3 Nozzle dome
3′ Wall thickness of nozzle dome
4 Feed borehole
5 Pressure chamber
6 Spray chamber
7 Nozzle needle
7′ Borehole
8 Needle tip
9 Passage
9′ Needle seat
10 Spray hole
11 Spray chamber wall
12 Inlet edge
13 Inlet opening
14 Pre-chamber
15 Constriction
16 Narrowing section
17 Guide channel
18 Outlet opening
19 Flow separation edge for the jet
20 Outside surface
21 Injection jet
22 Outlet angle
A . . . E Functional area

1. An injection nozzle, especially an orifice nozzle for an internal combustion engine, comprising:
a) a body in which a nozzle needle is displaceably guided;
b) a pressure chamber which communicates with a feed borehole and via a passage with a spray chamber, wherein the passage comprises a needle seat for cooperation with a needle tip of the nozzle needle, and
c) at least one injection orifice via which the spray chamber communicates with the outside of the body;
d) wherein the at least one injection orifice has a substantially bottleneck-like inner contour with at least one pre-chamber, which opens at one end with an inlet opening into the spray chamber, and a cylindrical guide channel which is connected to the other end of the at least one pre-chamber and communicates via an outlet opening with the outside (dome) of the body;
e) the at least one pre-chamber has a diameter or cross-section at least in the inlet opening which is at least 50% larger than the diameter or cross-section of the guide channel;
wherein the at least one pre-chamber comprises at least one constriction with at least one narrowing section; and
wherein a ratio of a length of the guide channel to a length of the pre-chamber lies in a range of 1:0.2 to 1:0.8.

2. An injection nozzle according to claim 1, wherein the inlet opening of the at least one pre-chamber is formed with rounded-off inlet edges.

3. An injection nozzle according to claim 2, wherein the rounded-off inlet edges of the inlet opening of the at least one pre-chamber are arranged with the same rounding-off radii.

4. An injection nozzle according to claim 1, wherein the at least one pre-chamber extends in circular-cylindrical arrangement up to the at least one constriction with the at least one narrowing section.

5. An injection nozzle according to claim 1, wherein the at least one pre-chamber is arranged in the manner of a truncated cone in the direction of the guide channel.

6. An injection nozzle according to claim 1, wherein the outlet opening of the guide channel is arranged with sharp edges.

7. An injection nozzle according to claim 1, wherein an outlet angle of the outlet opening of the guide channel, which outlet angle is formed by an outer surface of the body and an inner wall or the central axis of the guide channel, is less than 90°.

8. An injection nozzle according to claim 7, wherein the outlet angle of the outlet opening of the guide channel is arranged in the manner of a truncated cone.

9. An injection nozzle according to claim 1, wherein the at least one injection orifice comprises several functional areas (A-E) over its entire length, which functional areas are arranged sequentially on the same axis and rotationally symmetrically.

10. An injection nozzle according to claim 9, wherein a first functional area (A) comprises the inlet opening, a second functional area (B) comprises the at least one pre-chamber, a third functional area (C) contains the at least one constriction, a fourth functional area (D) comprises the guide channel, and a fifth functional area (E) comprises the outlet opening.

11. An injection nozzle according to claim 10, wherein at least one functional area (A-E) is provided several times.

12. An injection nozzle according to claim 10, wherein the bottleneck-like functional packet (A-E) is introduced in modulated drilling operations from the outside to the inside.

13. An injection nozzle according to claim 10, wherein the bottleneck-like functional packet (A-E) is combined into a modular unit and is pressed into a cylindrical injection orifice.

14. An injection nozzle according to claim 1, wherein the substantially bottleneck-like inner contour of the injection orifice depends further at least on the inner form, the volume, air swirling and the combustion pressure of an associated combustion chamber of the internal combustion engine.

15. An injection nozzle according to claim 11, wherein the bottleneck-like functional packet (A-E) is introduced in modulated drilling operations from the outside to the inside.

16. An injection nozzle according to claim 11, wherein the bottleneck-like functional packet (A-E) is combined into a modular unit and is pressed into a cylindrical injection orifice.
